(19) United States
(12) Patent Application Publication
(10) Pub. No.: US 2020/0331010 A1
(43) Pub. Date: Oct. 22, 2020

(54) METHOD FOR PRODUCING AN INSULATION PANEL

(71) Applicant: Hennecke GmbH, Sankt Augustin (DE)

(72) Inventors: Martin SCHAMBERG, Sankt Augustin (DE); Alexander STEEN, Bonn (DE)

(21) Appl. No.: 16/844,016

(22) Filed: Apr. 9, 2020

(30) Foreign Application Priority Data
Apr. 17, 2019 (DE) 10 2019 110 091.7

(51) Int. Cl. B05B 7/00; B05B 7/26; B05B 13/02

(52) U.S. Cl. CPC B05B 7/0018; B05B 13/0221; B05B 7/26

(57) ABSTRACT

A method for producing an insulation panel, including a cover layer and a layer of insulating material located thereon, between which the layer of insulating material is located. The insulating material is produced by metering at least two components of a reactive mixture, mixing and feeding them to an inlet of a distributor. The reactive mixture is guided in the distributor along a flow path to at least five nozzle openings and discharged. The reactive mixture is applied from each nozzle opening in a free jet onto the upper side of the cover layer which moves in a conveying direction relative to the distributor. The impact points of the jet of reactive mixture on the cover layer lie substantially on a line which extends transversely to the conveying direction. The distance of the two laterally outermost impact points is at least 70% of the width.

### CROSS-REFERENCE TO RELATED APPLICATIONS

The present application claims priority of DE 10 2019 110 091.7, filed Apr. 17, 2019, the priority of this application is hereby claimed and this application is incorporated herein by reference.

### BACKGROUND OF THE INVENTION

The invention relates to a method for producing an insulation panel of predetermined width, comprising at least one cover layer and a layer of insulating material (especially insulating foam) located thereon, preferably comprising two cover layers, between which the layer of insulating material is located, wherein the insulating material is produced by metering at least two components of a reactive mixture, mixing the same and feeding them to an inlet of a distributor, wherein the reactive mixture being guided in the distributor along a flow path to a number of nozzle openings and being discharged via the nozzle openings, wherein the reactive mixture being applied to the upper side of the at least one cover layer which moves in a conveying direction relative to the distributor, wherein the reactive mixture is discharged via at least five nozzle openings, wherein the reactive mixture is applied from each nozzle opening in a free jet onto the upper side of the cover layer, wherein the impact points of the jet of reactive mixture on the cover layer lie substantially on a line which extends transversely to the conveying direction and wherein the distance of the two laterally outermost impact points is at least 70% of the width.

A generic method is known from EP 2 051 818 B1. Similar solutions are shown in EP 1 857 248 B1, in WO 2012/093129 A1, in WO 2008/104492 A2 and in US 2005/0222289 A1.

Such a process is particularly suitable for producing foam composite elements with flexible or rigid cover layers. Such composite elements are used especially for insulation purposes. Usually such composite elements are produced on continuously operating machines. Today, production speeds of up to 60 m/min are achieved. Typically, such composite elements are produced in widths of approx. 1,200 mm, but widths of 600 mm to 1,500 mm are also possible for various applications.

The basic method for continuous production of steel sandwich panels is described in DE 16 09 668 A1. In EP 1 516 720 B1 it is described that beside metal cover layers, flexible cover layers such as paper or non-woven fabrics can also be used. In EP 1 857 248 B1 it is explained that the previously common oscillating application by means of a casting rake is limited with regard to production speed. The process with oscillating application is described, for example, in U.S. Pat. No. 4,278,045A.

As an alternative, the above-mentioned EP 1 857 248 B1 proposes a process in which the reaction mixture is distributed via a distribution head to at least three flexible outlet lines, the flexible outlet lines being attached to a rigid frame transverse to the direction of outflow. The disadvantage of this method is that it is difficult to avoid caking of reaction mixture within the hoses. In order to avoid this, a high air load must be used, which then has to be generated on the pressure side instead of the suction side of the dosing pump, which is more complicated in terms of machine technology. With more reactive systems, however, the process reaches its limits even with a high air load, as the hose cross-sections narrow over time. This leads to increased pressure losses. If caking does not start exactly evenly in all hoses, this leads to uneven distribution of the quantities in the individual outlet lines. This in turn leads to internal stresses in the finished component, which cause the finished composite element to bulge during the cooling process.

An alternative solution is a standing casting rake. This is basically a rigid pipe, which is positioned essentially transverse to the conveying direction. This tube has a large number of outlet openings through which the reaction mixture is discharged. Different designs of such rakes are described in EP 2 051 818 B1, in WO 2008/104492 A2 and in WO 2012/093129 A1. A major problem with such rakes is that the reaction mixture cakes up over a longer period of time starting with the outer holes. The residence dwell time of the material within the casting rake is very long in the outer areas. In addition, the flow velocities are generally lower there, since adjusting the flow cross-section to prevent this effect results in the total flow resistance for the material with the longest flow paths becoming so large compared to the total flow resistance for the material with the shortest flow paths that the quantity distribution becomes uneven. A further problem is the poor age distribution, as the material with the longest flow paths is significantly older when it leaves the rake than the material with the shortest flow paths. Although there are various proposals to counter these problems with different measures, the basic problem of a relatively long residence time and a relatively high specific surface area within such casting rakes remains.

The problem with the solutions mentioned above is that at least parts of the reaction mixture in the solutions mentioned have relatively long flow paths before the material is discharged into the atmosphere. A further disadvantage of these solutions is that the solutions have a relatively large specific surface area in relation to the volume flow. Since the reactive, sticky reaction mixture can potentially bake to surfaces over time, it is advantageous to design discharge elements in such a way that they have the smallest possible specific surface area in relation to the volume flow rate.

An advantageous solution in this respect is disclosed in FIG. 5 of US 2005/0222289 A1. However, this relatively simple solution with one central and two lateral jets has the disadvantage that three strands lead to very pronounced confluence zones in the later product. These confluence zones result in a very uneven and unfavorable cell orientation, which has a negative effect on the mechanical properties. In addition, with only three strands it is difficult to design the process in such a way that there are no large air inclusions during the confluence, as it is more difficult to avoid overflowing of the reaction mixture after the material has reached the upper limitation with only three strands. Therefore this solution does not work in reactive systems with low start and rise times.

The solution to the problem presented in the aforementioned US 2005/0222289 A1 by means of an application using several flat jet nozzles brings another problem with it: The relatively high impulse of the flat jets ensures that the material also flows against the transport direction. Since the flat jet is a broadly drawn flat jet, the reaction mixture flowing against the transport direction has no possibility to avoid the impinging jet by passing it laterally. Instead, the flat jet inevitably hits the material flowing initially against the transport direction, which is then carried along by the moving surface layer in the transport direction. This results in considerable impact of air bubbles. In addition, it is almost impossible to achieve an even distribution of the material across the width with a flat jet. The undefined quantity distribution achieved with a flat jet (especially at the edges, there is an accumulation of material because the surface tension ensures that the flat jet is pulled together on the outside) is more problematic from a process engineering point of view than the defined distribution achieved with individual discrete but defined strands. In the case of flat jets, it is therefore more difficult in reality to avoid air inclusions under the upper cover layer.

In addition, the process proposed in US 2005/0222289 A1, like the process described in EP 1 857 248 B1, has the disadvantage that, depending on the reactivity of the foam system, it is difficult to prevent material from caking to the walls of the distribution system, even during productions lasting several hours.

It should be noted here that one prefers to use very reactive systems in order to avoid the effect of the so-called Ostwald ripening, in which smaller bubbles disappear in the foam, especially towards the end of the rising time, by diffusing into the neighbouring larger bubbles. This deteriorates the insulating properties. With faster systems, this process is limited to a shorter time window, so faster systems can be used to produce finer-cell end products with better insulating properties. The effect of Ostwald ripening is described in detail in EP 3 176 206 A1, for example. This publication also discusses the importance of the fine-cell structure of a foam structure in relation to the insulating properties.

### SUMMARY OF THE INVENTION

In the light of the various problems described above, the present invention is based on the object of further developing a generic process in such a way that it is possible to ensure an even application of the reaction mixture to the continuously moving surface layer, while at the same time ensuring that even in the case of long productions and reactive systems, caking of reaction mixture on the walls of the distributor can be reliably prevented. A further essential aim of the present invention is to apply the material in such a way that the age of the reactive mixture is as homogeneous as possible on an imaginary plane orthogonal to the conveying direction. An inhomogeneous age distribution of the different strands leads to problems in the coalescence of the different strands and to inhomogeneous physical properties of the end product, which should be avoided according to the invention. A particularly critical effect here is that the composite elements bend due to internal stresses on cooling and are no longer flat. Furthermore, the aim is to avoid or minimize bubble impact when applying the reactive mixture to the cover sheet.

The solution of this object by the invention is characterized in that the (average) age of the reactive mixture in each jet discharged from the nozzle opening differs from an arithmetic mean value over all the jets by at most 0.5 seconds when intersecting a plane perpendicular to the conveying direction, wherein the distributor has a volume flow specific surface area which is at most 2.0 cm²/(cm³/s) (quotient of the surface area in contact with reactive mixture and the volume flow of reactive mixture passing through the distributor).

The mixing of the components to the reactive mixture is first carried out in a central mixing element before it is transferred to the inlet of the distributor. The reactive mixture is discharged into the atmosphere through the nozzle openings and reaches the cover layer in a free jet (i.e. in the shape of a throwing parabola). The cover layer usually moves in the horizontal conveying direction.

The choice of at least five nozzle openings has the advantageous consequence that a relatively defined cell orientation can be achieved even in the confluence zones. The desired cell orientation is one in which the cells are also, and especially in the area immediately below the upper cover layer, slightly stretched vertically, as this has a positive effect on the mechanical properties of the panel. With less than five strands, the individual strands are pressed outwards very strongly after the reactive mixture has reached the upper limitation. This results in a chaotic and unfavorable cell orientation in the confluence zones. Furthermore, with at least five strands, it is easier to avoid over-rolling the material after the reactive mixture has reached the upper limitation.

It is advantageous to provide a clean tear-off edge at the nozzle openings, so that no collar can form at the outlet side of the nozzle opening, which could adversely affect the trajectory of the material over a longer production period. In this respect, it is preferably advantageous to provide a tapered outer nozzle contour (greater than 90°).

The proposed design also ensures that the corners and edges of the product to be manufactured are properly filled with reactive mixture.

Since the impact points of the jet of reactive mixture on the cover layer are to lie substantially in line, it is in particular and preferably provided in this respect that all impact points on the surface layer lie in a section extending over a maximum of 200 mm, preferably over a maximum of 100 mm, in the conveying direction. The impact points of the jets on the continuously moving cover layer are thus preferably within a corridor of a maximum of 200 mm in the conveying direction. This ensures a good age distribution. The operating parameters of the distributor (in particular the volume flows and pressures of the reactive mixture) and its geometric design (in particular the position and alignment of the individual nozzles or nozzle openings on the distributor) are carried out expertly in order to implement the above-mentioned procedure.

The reactive mixture in the distributor is preferably led from the inlet to the nozzle openings over a maximum length of 150 mm. This design has the advantage that there is less caking of material at the walls in the distributor. Especially in combination with high flow velocities this disadvantageous effect is further reduced. In this respect, it is particularly and preferably provided that the (average) outlet velocity of the reactive mixture from the nozzle openings is between 1.5 m/s and 5.0 m/s. The above-mentioned range has proved to be optimal, since too low velocities mean that the jets do not reach far enough or, as a consequence, the distributor must be positioned very high. However, too high speeds lead to spraying during application.

Furthermore, it is preferably intended that the (average) residence time of the reactive mixture in the distributor is at most 0.15 seconds. Such a short residence time is particularly advantageous for reactive systems in order to prevent caking at the walls of the distributor.

The age of the mixture at a specific point is understood to be the time which has elapsed since the reactive mixture entered the inlet of the distributor until it reaches the specific point. Thus, the average age of the reactive mixture in the different strands in an imaginary plane orthogonal to the conveying direction deviates from each other by a maximum of 1 second. Such a favourable age distribution is important to avoid internal stresses in the finished component, which could lead to a bulging of the component during cooling.

All jets of the reactive mixture in the direction transverse to the conveying direction preferably hit the cover layer at an essentially equal distance. In particular, a tolerance range of 20% of the distance from the adjacent jet applies to all jets of the reactive mixture. For the points of impact of the jets on the continuously moving layer transverse to the transport direction, there are thus equidistant distances with a tolerance of a maximum of +/−10%. Such an even distribution is important for an even coalescence of all strands after the material has reached the cover layer. Otherwise it can be difficult to achieve complete filling or good density distribution. Uneven distribution can again lead to internal stresses during cooling, which can then lead to distortion of the finished panels.

The two laterally outermost nozzle openings preferably discharge the reactive mixture in two directions, which together form a plane, whereby the two directions intersect at an angle between 90° and 180°. In this respect, the velocity vectors of the jets emerging from the two outer nozzles lie within vertically aligned planes which include the aforementioned angle.

The volume flow specific surface area according to the invention is the quotient of the surface in contact with the reactive mixture and the volume flow of reactive mixture passing through the distributor. Such a low specific surface is in turn very advantageous for reactive systems in order to prevent caking on the walls of the distributor.

Preferably, the width of the distributor in the direction (horizontal and) transverse to the conveying direction is at most 25% of the width of the insulating panel to be produced, preferably at most 15% of this width.

At moving cover layer, the distributor is preferably arranged stationary.

The width of the insulating panels produced is typically around 1,200 mm; widths between 600 mm and 1,500 mm can also be provided for various applications.

The various features of novelty which characterize the invention are pointed out with particularity in the claims annexed to and forming a part of the disclosure. For a better understanding of the invention, its operating advantages, specific objects attained by its use, reference should be had to the drawings and descriptive matter in which there are illustrated and described preferred embodiments of the invention.

### BRIEF DESCRIPTION OF THE DRAWING

In the drawing:

FIG. 1 shows schematically a perspective view of a distributor (i.e. a distributor element) with which reactive mixture is applied to a cover layer in order to produce an insulation panel,

FIG. 2 shows the section through the distributor with depicted flow path to one of the nozzle openings,

FIG. 3 shows the top view of the distributor with the jets of reactive mixture emerging from it,

FIG. 4 shows the front view of the distributor and

FIG. 5 shows the side view of the distributor.

### DETAILED DESCRIPTION OF THE INVENTION

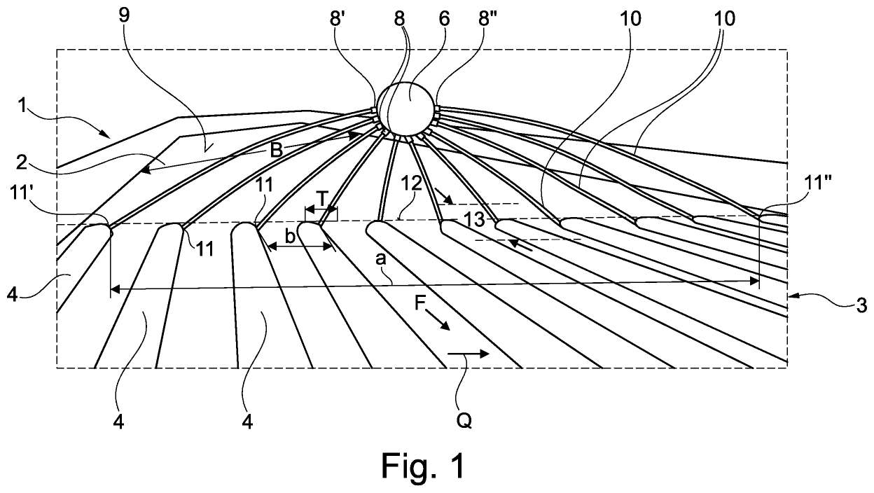

FIG. 1 shows schematically an installation used to produce an insulating panel 1 (insulating panel as a foam composite element) by applying a layer of insulating material 3 in the form of a polyurethane reactive mixture 4 to a cover layer 2. The insulating panel 1 has a width B.

Here, the cover layer 2 moves below a stationary distributor 6, from which the reactive mixture 4 is discharged, in a conveying direction F at constant speed.

As can be seen in synopsis with the other figures, the polyurethane reactive mixture 4 is discharged from the distributor 6 in the form of a number of jets 10, i.e. the reactive mixture 4 is ejected through nozzle openings 8 in the distributor 6 so that it reaches the cover layer 2 as a free jet following the shape of a flight parabola, as can best be seen in FIG. 1, where it contacts the upper side 9 of the cover layer 2 at a corresponding number of impact points 11.

In the shown embodiment, eleven jets 10 are provided, whereby the number of jets 10 is, according to the invention, at least five; seven and nine jets 10 have also proved to be particularly effective; it is also essential that the mentioned impact points 11 of the respective jets 10 of reactive mixture 4 on the cover layer 2 lie essentially on a line 12 which runs transversely to the conveying direction F, which is designated with Q. It is further provided that the distance a (see FIG. 1) of the two laterally outermost impact points 11′ and 11″ is at least 70% of the width B.

The fact that the jets 10 reach the cover layer 2 essentially along line 12 is specified by the fact that the said impact points 11 are intended to be located within a section 13 (see FIG. 1), which preferably extends over a maximum of 100 mm in conveying direction F.

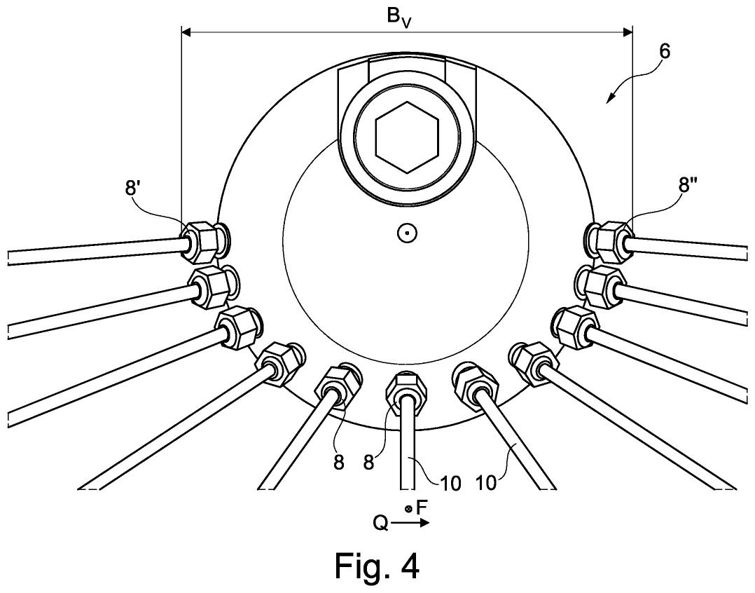

The width By (see FIG. 4) of the distributor 6, i.e. its extension in the direction Q horizontally and transversely to the conveying direction F (and thus also the width of the region of the distributor 6 provided with nozzle openings 8), is preferably at most 25% of the width B of the insulating panel to be produced, particularly preferably at most 15% of the width B.

The individual jets 10 should reach the upper side 9 of the cover layer 2 as equidistantly as possible in direction Q. FIG. 1 illustrates that for this purpose, it is intended that said impact point 11 should lie within a tolerance range T, preferably at a maximum of 20% of the distance b from the adjacent jet 10, on the basis of an equidistant spacing of the individual jets 10.

Accordingly, eleven jets 10 are discharged from the distributor 6 in the shown embodiment, which reach the cover layer 2 moving continuously in horizontal direction and are then transported further in the form of eleven strands.

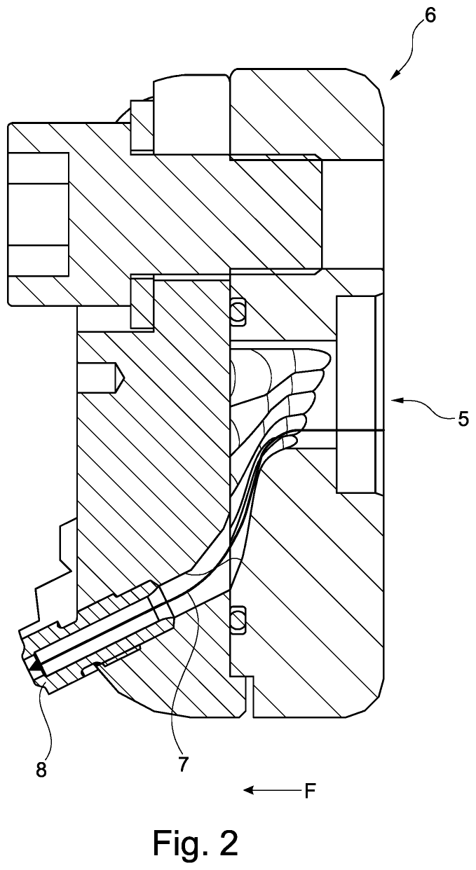

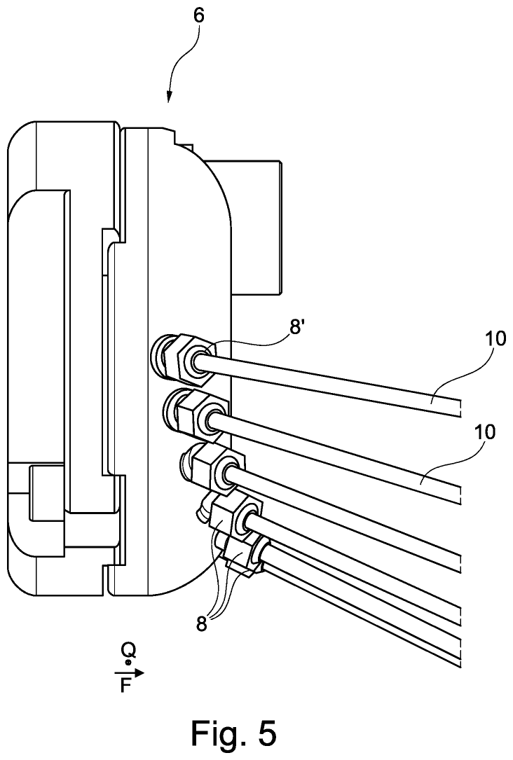

Details of distributor 6 can be found in the other FIGS. 2 to 5.

FIG. 2 shows the section through the distributor, whereby the section runs exactly through the central one of a total of eleven flow paths 7. From this it can be seen that the distributor 6 has an inlet 5 by which it is fed with the reactive mixture 4 from a mixer (not shown). The reactive mixture 4 is then conveyed along a flow path 7 in order to reach a nozzle opening 8, through which it is ejected as jet 10 in the manner described. To prevent caking, the flow path 7 is preferably at most 150 mm long.

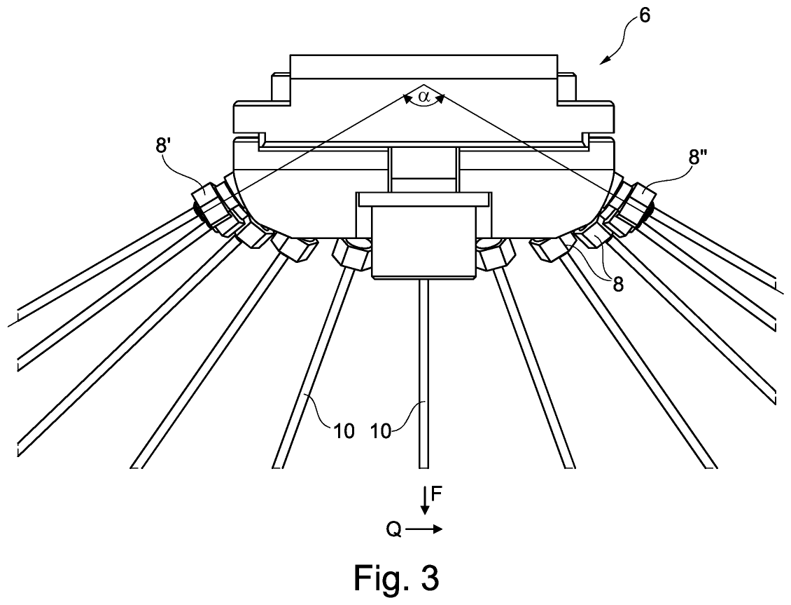

The plan view according to FIG. 3 shows that the two outermost nozzle openings 8′ and 8″ are arranged so that the direction of ejection from them includes an angle a of between 90° and 180°. The lines drawn therefore indicate the longitudinal axes of the two outermost nozzles 8′ and 8″.

As further shown in the figures, the nozzle openings 8 spray the reactive mixture 4 in conveying direction F, i.e. with the movement of the cover layer 2, which moves at a constant speed under the stationary distributor 6 in conveying direction F.

As can be seen from FIGS. 3 to 5 regarding the arrangement and orientation of the individual nozzle openings 8, the individual nozzle openings or nozzles are arranged at very different angles to the horizontal. The outer nozzle openings are arranged at a much smaller angle to the horizontal. The workmanlike design ensures the above-mentioned aim of placing the impact points 11 next to each other in transverse direction Q along line 12 at given operating parameters.

With the proposed design it is achieved that the reactive mixture 4 is finally applied as a very homogeneous layer 3 to the cover layer 2, so that the quality of the insulating panel to be produced can be optimized.

While specific embodiments of the invention have been shown and described in detail to illustrate the inventive principles, it will be understood that the invention may be embodied otherwise without departing from such principles.

We claim:

1. A method for producing an insulation panel of predetermined width, comprising at least one cover layer and a layer of insulating material located thereon, preferably comprising two cover layers, between which the layer of insulating material is located, wherein the insulating material is produced by metering at least two components of a reactive mixture, mixing the same and feeding them to an inlet of a distributor, wherein the reactive mixture being guided in the distributor along a flow path to a number of nozzle openings and being discharged via the nozzle openings, wherein the reactive mixture being applied to the upper side of the at least one cover layer which moves in a conveying direction relative to the distributor,
wherein the reactive mixture is discharged via at least five nozzle openings,
wherein the reactive mixture is applied from each nozzle opening in a free jet onto the upper side of the cover layer,
wherein the impact points of the jet of reactive mixture on the cover layer lie substantially on a line which extends transversely to the conveying direction, and
wherein the distance of the two laterally outermost impact points is at least 70% of the width,
wherein the age of the reactive mixture in each jet discharged from the nozzle opening differs from an arithmetic mean value over all the jets by at most 0.5 seconds when intersecting a plane perpendicular to the conveying direction, wherein the distributor has a volume flow specific surface area which is at most 2.0 cm²/(cm³/s) (quotient of the surface area in contact with reactive mixture and the volume flow of reactive mixture passing through the distributor).

2. The method according to claim 1, wherein all impact points on the cover layer lie in a section which extends over a maximum of 200 mm, preferably over a maximum of 100 mm, in the conveying direction.

3. The method according to claim 1, wherein the reactive mixture is guided in the distributor from the inlet to the nozzle openings over a maximum length of 150 mm.

4. The method according to claim 1, wherein the exit velocity of the reactive mixture from the nozzle openings is between 1.5 m/s and 5.0 m/s.

5. The method according to claim 1, wherein the residence time of the reactive mixture in the distributor is at most 0.15 seconds.

6. The method according to claim 1, wherein all the jets of the reactive mixture impinge on the cover layer in a direction transverse to the conveying direction at substantially equal distances.

7. The method according to claim 6, wherein a tolerance range of 20% of the distance from the adjacent jets applies to all jets of the reactive mixture.

8. The method according to claim 1, wherein the two laterally outermost nozzle openings discharge the reactive mixture in two directions which together define a plane, the two directions intersecting at an angle between 90° and 180°.

9. The method according to claim 1, wherein the width of the distributor in the direction transverse to the conveying direction is at most 25% of the width of the insulation panel to be produced, preferably at most 15% of the width of the insulation panel.

10. The method according to claim 1, wherein the distributor is arranged in a stationary position and the cover layer is moving.
